(19) United States
(12) Patent Application Publication
(10) Pub. No.: US 2021/0309870 A1
(43) Pub. Date: Oct. 7, 2021

(54) Fabricating Porous Metallic Coatings Via Electrodeposition and Compositions Thereof

(71) Applicant: Virginia Tech Intellectual Properties, Inc., Blacksburg, VA (US)

(72) Inventors: Atieh Haghdoost, Blacksburg, VA (US); Ranga Pitchumani, Blacksburg, VA (US); Mehdi Kargar, Blacksburg, VA (US)

(73) Assignee: Virginia Tech Intellectual Properties, Inc., Blacksburg, VA (US)

(21) Appl. No.: 17/347,508

(22) Filed: Jun. 14, 2021

Related U.S. Application Data
(62) Division of application No. 16/189,065, filed on Nov. 13, 2018, now abandoned.
Application No. 16/189,065 is a division of application No. 14/765,930, filed on Aug. 5, 2015, now abandoned.
(60) Provisional application No. 61/765,438, filed on Feb. 15, 2013.

(51) Int. Cl. C09D 7/61; B01J 37/02; B01J 37/34; B01J 23/72; C25D 3/38; C25D 5/00; C25D 21/12; B01J 35/00; B05D 5/08; C09D 5/16; C09D 1/00; C09D 5/24; C09D 5/44; C25D 5/10; C25D 5/16; C25D 9/02

(52) U.S. Cl. CPC C09D 7/61; C08K 2003/085; B01J 37/348; B01J 23/72; C25D 3/38; C25D 5/00; C25D 21/12; B01J 37/0225; B01J 37/0244; B01J 35/002; B05D 5/08; C09D 5/1681; C09D 1/00; C09D 5/24; C09D 5/448; B01J 35/0006; C25D 5/10; C25D 5/16; C25D 9/02; B01J 37/0217; B01J 37/0238

(57) ABSTRACT

A method is provided for creating a porous coating on a surface of a substrate by electrodeposition. The substrate is a part of the cathode. An anode is also provided. A coating is deposited or disposed on the surface by applying a voltage that creates a plurality of porous structures on the surface to be coated. Continuing to apply a voltage creates additional porosity and causes portions of the attached porous structures to detach. A covering layer is created by applying a voltage that creates a thin layer that covers the attached porous structures and the detached portions which binds the porous structures and detached portions together.

### CROSS-REFERENCE TO RELATED APPLICATIONS

This application claims the benefit U.S. Provisional Application No. 61/765,438, filed Feb. 15, 2013 and herein incorporated by reference.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Field of the Invention

The manufacture and use of porous coatings on surfaces have received great interest due to their importance in both fundamental research and commercial applications. In particular, porous metallic coatings are widely used as catalysts or utilized to enhance bonding of paints and polymers to the metal surfaces. Anodizing is one of the best-known processes for making porous metallic coatings. However, anodizing has several limitations such as those on the choice of coating material and substrate. In fact, anodizing is mainly used to make porous alumina coatings on aluminum. In this process, an aluminum substrate acts as an anode of an electrochemical cell and by applying an electric voltage both oxidation and dissolution processes occur on its surface. As a result, the top layer of aluminum is converted to porous alumina. Anodized alumina is used as a catalyst or utilized to enhance polymer-to-aluminum bonding. In addition, alumina coatings protect the underlying aluminum metal from corrosion. Alumina is an insulating material and application of its anodized coating in high-temperature catalytic reactions raises a serious cracking problem. In addition to aluminum, an anodizing process can be used to cover a few other metals such as titanium and magnesium with their own porous oxide coatings. In fact, an anodizing process can be applied on a very limited number of substrate materials. In addition, using anodization, only a single specific porous coating can be made on any given substrate material.

In addition to the mentioned applications, porous coatings have been used to create superhydrophobic (non-wetting) surfaces that have been inspired by the lotus leaf effect—the naturally occurring superhydrophobic effect exhibited by the leaves of the lotus flower due to its complex micro- and nanoscopic surface. Superhydrophobic coatings have received great interest in recent years due to their importance as a potential corrosion protection technology. These coatings completely repel aqueous solutions and, as a result, dramatically reduce the contact of the surface with a corrosive media.

On superhydrophobic surfaces, a sessile droplet shows an apparent contact angle higher than 150°. In addition, a dynamic droplet does not stick to these surfaces. Several methods are used to demonstrate and measure the non-wetting characteristic of a superhydrophobic surface such as showing that a falling droplet bounces off a superhydrophobic surface after impact. Another is that there is typically a low contact angle hysteresis, i.e., small difference between the contact angles at the front and back of a moving droplet. It is already known that a combination of surface chemistry and surface topography is required to support the aforementioned criteria for superhydrophobicity. If the contact angle of the smooth surface is around 90°, a superhydrophobic state can be obtained by designing proper surface topographical features. In particular, roughness at two or more length scales has been shown to cause superhydrophobicity in the lotus leaf and other naturally occurring superhydrophobic materials. A sessile drop interacting with a rough surface may fully wet the surface, which is known as the Wenzel wetting regime (WE) or it may result in Cassie-Baxter regime (CB) in which air pockets are entrapped underneath the drop and a composite interface (liquid-solid-air) is formed. Reduction of the liquid-solid contact area in the CB regime results in both high apparent contact angles (a) and low contact angle hysteresis; therefore the CB regime supports the criteria of superhydrophobicity.

Many methods have been used to fabricate superhydrophobic surfaces, such as sol-gel processing, self-assembly technique, electrospinning, hydrothermal synthesis, laser etching, plasma etching, physical and chemical vapor deposition, anodic oxidation, and spray methods. Some of these techniques for making superhydrophobic surfaces can be costly and time-consuming, making them impractical for many applications. Most of these techniques are used to make polymer- or silica-based coatings which may exhibit delamination problems on the metallic substrates.

Moreover, for some of the applications, the effects of the superhydrophobic coating on thermal and electrical conductivity of the substrate need to be minimized. As a result, the insulating coating created by most of the above techniques has additional drawbacks. Among the conductive coatings, superhydrophobic copper coatings have attracted considerable interest due to their high diathermanous and electric performance in addition to having desirable thermal and mechanical stability. In some of the techniques for making superhydrophobic copper surfaces, besides formation of surface topographical features, the chemistry of the copper surface is changed, which may result in undesirable changes in the essential surface properties. In addition, in some techniques, the topmost layer of the copper surface is transformed to a superhydrophobic film while for most of the applications, coating a substrate with an additional layer of a superhydrophobic copper film is desired.

Electrodeposition or electroplating is a well-known coating technique that can be utilized to make uniform coatings regardless of the surface size and shape. Template-assisted electrodeposition has been utilized to coat surfaces with a patterned layer of a superhydrophobic metal deposit. In that technique, the texture of the deposit depends on the template structure, which may be adversely affected by the template fabrication step. Due to this reason, template-free electrodeposition methods have been used. One such application deposits hierarchical spherical cupreous microstructures from an aqueous solution of Cu(NO₃) by applying a constant overpotential and further hydrophobized the deposit surface by a self-assembled monolayer of n-dodecanethiol. In addition, another method uses a two-step procedure to deposit a hydrophobic copper film: the first step at a low overpotential in order to create nucleation sites and the second step at a high overpotential for the growth of particles on the nucleation sites. Afterward, the method enhances the wettability of the copper deposit to the superhydrophobic region by applying a self-assembled monolayer of an n-alkanoic acid. In yet another method, a copper deposit with dense-branching morphology is made by applying a specific current density and a layer of a fluorocarbon coating is used to make the deposit superhydrophobic.

In the aforementioned methods, the morphological instabilities that are inherently made during electrodeposition are enhanced by applying an appropriate overpotential or current density. These instabilities provide the surface texture required for the hydrophobic state but in all of these methods, superhydrophobicity is not obtained without applying an additional layer of a low-surface-energy material. The endurance of this additional layer strongly affects the superhydrophobic characteristic of these surfaces and therefore, delamination of this layer is a serious issue for the superhydrophobic surfaces made using the above techniques.

Lastly, corrosion is a major industrial problem which directly affects a wide range of industry sectors, from transportation to production and manufacturing. The annual direct cost of corrosion in the US is estimated at a staggering $276 billion, approximately 3.1% of the nation's Gross Domestic Product. Currently, protective coatings are the main existing preventive strategy. These coatings prevent corrosion of the protected metal by forming a physical barrier against a corrosive environment. Both polymeric and metallic protective coatings are used. Metallic coatings such as zinc and copper coatings naturally develop thin shielding outer-layers against corrosion. The shielding layer is made of a hard and relatively passive material such as metal oxide which can partially protect the underlying metals from corrosion. A similar passivation mechanism is seen for some other metals such as aluminum, chromium, and titanium. The thin layer produced by the passivation mechanism does not provide complete protection and usually additional protective mechanisms are sought. Corrosion usually starts on contact with water; therefore, a promising corrosion protection strategy is to keep the surfaces dry. Superhydrophobic coatings repel moisture and keep the surfaces dry. Consequently, these coatings offer a new preventive technology to help alleviate the corrosion problem. Metallic superhydrophobic coatings are potentially a highly effective corrosion protection approach because they combine non-wetting characteristics with the passivation mechanism of metal.

### BRIEF SUMMARY OF THE INVENTION

The present invention provides a porous metallic coating and method for making the same that overcomes many of the disadvantages of the methods discussed above. The resulting metallic coating can be applied on any metallic substrate or at least one region of surface using a low-cost multiple stepped, phased and/or sequenced electrodeposition process.

In addition, in one embodiment of the present invention, the copper superhydrophobic coatings of the invention add a non-wetting characteristic to the passivation mechanism of copper, thereby increasing the overall effectiveness of the coating for corrosion protection.

In general, the present invention provides a template-free electrodeposition method to produce a superhydrophobic porous metallic coating such as a copper coating with a water contact angle of 160°±6° and contact angle hysteresis of 5°±2°. A metallic deposit with multi-scale surface features is formed by applying a voltage having a high overpotential. This results in the formation of structures with dense-branching morphology, which are loosely attached to the surface. Alternately, this step may be repeated as desired. Subsequently applying a lower overpotential for a short time creates a thin layer of material that reinforces the loosely attached branches on the surface and binds the structure together into a solid composite. Alternately, this subsequent step may be repeated as desired as well. The resulting surface textures of the porous metallic coating have superhydrophobic characteristics and resist delamination. In this disclosure, delamination refers to the separation of any portion of the coating from the substrate or a portion of the coating from the coating itself.

Moreover, unlike anodizing, the multiple-phase electrodeposition process of the present invention may be used to make conductive porous coatings of different metals on any desirable metallic substrate. Alternately, the metallic porous coating may be of the same metal as the substrate or region of a surface to which it is applied. Moreover, scale-up manufacturing of the process may be easily accomplished using the same process lines available in the industry for making anodized alumina.

Equally important, many of the non-wetting products currently available in the market are made of polymer or silica which exhibit delamination problems. Compared to the existing technologies, the porous coatings of the present invention do not have a delamination problem. In addition, the porous metallic coatings do not negatively affect the thermal and electrical conductivity of the substrate. Lastly, the coatings of the present invention may be made of earth-abundant and eco-friendly metals and their applications are not affected by the regulatory legislations such as REACH (Registration, Evaluation, and Authorization of Chemicals), VOC (Volatile Organic Compound), and RoHS (Restriction of Hazardous Substances).

Growth of morphological instabilities during electrodeposition can be explained using the models presented in the literature for the unstable growth process. Most of these models discuss the electrodeposition systems at the limiting condition, which corresponds to the mass transfer limitation of the system. After reaching the limiting condition, the concentration of the metal ion on the deposit surface falls to zero and the distribution of the local current density or the local deposition rate is mainly controlled by the mass transfer process in the electrolyte. Mass transfer favors the growth of arbitrary protrusions on the surface and enhances the morphological instabilities of the deposit. Unlike mass transfer, surface tension acts to stabilize the growth process by relating surface curvature to the local surface potential. Based on this relationship, the surface potential is higher at the curved locations of the deposit and consequently, less growth rate is expected at these locations compared to the flat areas. The stabilizing effect of the surface tension is only effective for very small protrusions but in general, the surface texture of the deposit is defined by the competing effects of mass transfer and surface tension. The mass transfer effect increases by increasing overpotential while surface tension at the interface of the metal-electrolyte decreases when higher overpotentials are applied.

Mass-transfer controlled deposition and low surface tension promote an unstable growth process at the limiting condition. After reaching the limiting condition, the current density remains constant with increasing overpotential, the change of the deposit surface structure at the limiting condition is more appropriately attributed to the change in the overpotential.

As discussed above, the present invention is directed at a deposition process in which the formation of a porous deposit occurs at a relatively high overpotential, far from the initiation of the limiting condition. The growth of this deposit is so unstable that morphological instabilities can grow both on the deposit surface and in the electrolyte adjacent to the deposit surface. Consequently, the deposit surface is covered by porous structures with densely-branched morphology, which are either a part of the surface or loosely attached to the surface. Generally, loosely-attached structures are formed beyond a certain stage in several unstable growth processes. The porous deposits made from a concentrated electrolyte exhibit superhydrophobicity due to the reentrant geometry of its surface structures. To reinforce the loosely attached structures on the deposit surface, an additional thin layer of the deposit is made in a subsequent step by applying a low overpotential for a short time. Alternately, the steps described above may be repeated as desired.

The electrodeposition or electroplating process of the invention may be used to create hydrophobic and/or superhydrophobic coatings without the need for an additional layer of a low-surface-energy material. An additional layer of a low-surface-energy material can be applied on the surface of the coating to improve its hydrophobic and/or superhydrophobic property even further, though the hydrophobicity and/or superhydrophobicity would not be dependent on the endurance of the additional layer and if this layer is scratched or delaminated, the surface would still be hydrophobic and/or superhydrophobic. The present invention provides a low-cost approach for coating metallic surfaces with an enduring porous coating that may also have hydrophobic and/or superhydrophobic properties. In addition, other applications for the metallic porous coatings of the invention include use as catalyst and improved surfaces for metal-to-polymer bonding.

### BRIEF DESCRIPTION OF THE SEVERAL VIEWS OF THE DRAWINGS

FIG. 1 is a schematic of the electrodeposition process of one embodiment of the present invention.

FIG. 2A is a schematic illustration of one embodiment of the present invention showing deposit covered with porous structures.

FIG. 2B is a schematic illustration of one embodiment of the present invention wherein both attached and detached porous structures are formed.

FIG. 2C is a schematic illustration of one embodiment of the present invention showing attached and detached porous structures bound together and affixed to a substrate by a thin reinforcing layer or covering layer.

FIG. 3A is a photograph showing the non-stick nature of a superhydrophobic coating made in accordance with one embodiment of the present invention.

FIG. 3B is a photograph showing how a water droplet may be easily removed from a superhydrophobic coating made by one embodiment of the present invention.

FIG. 3C is a photograph showing a droplet adhering to a non-superhydrophobic coating.

FIG. 3D is a photograph showing a droplet resisting removal from a non-superhydrophobic coating.

FIG. 4 is a micrograph showing a deposit made in accordance with the present invention at overpotential of 0.1V.

FIG. 5 is a micrograph showing the contact angle and shape of a water droplet on the surface created by the deposit shown in FIG. 4.

FIG. 6 is a micrograph showing a deposit made in accordance with the present invention at overpotential of 0.3V.

FIG. 7 is a micrograph showing the contact angle and shape of a water droplet on the surface created by the deposit shown in FIG. 6.

FIG. 8 is a micrograph showing a deposit made in accordance with the present invention at overpotential of 0.5V.

FIG. 9 is a micrograph showing the contact angle and shape of a water droplet on the surface created by the deposit shown in FIG. 8.

FIG. 10 is a micrograph showing a deposit made in accordance with the present invention at overpotential of 0.7V.

FIG. 11 is a micrograph showing the contact angle and shape of a water droplet on the surface created by the deposit shown in FIG. 10.

FIG. 12 is a micrograph showing a deposit made in accordance with one embodiment of the present invention at overpotential of 0.9V.

FIG. 13 is a micrograph showing the contact angle and shape of a water droplet on the surface created by the deposit shown in FIG. 12.

FIG. 14 is a micrograph showing a deposit made in accordance with one embodiment of the present invention at overpotential of 0.11V.

FIG. 15 is a micrograph showing the contact angle and shape of a water droplet on the surface created by the deposit shown in FIG. 14.

FIG. 16 is a photograph of the residue on a piece of transparent adhesive tape after a tape test of one-layer deposit without the reinforcing layer.

FIG. 17 is a photograph of the residue on a piece of transparent adhesive tape after a tape test of a coating with the reinforcing layer.

FIG. 18 is a micrograph of a two-layer deposit showing the cross section of one of the florets revealed through a cut made by ion beam.

FIG. 19 shows successive snapshots obtained from the full rebound of a 4.5 μL droplet on a coating made by the electrodeposition technique of one embodiment of the present invention.

FIG. 20 is chart showing the XPS spectra of copper-colored deposits made by applying overpotential of (a) 1.1 V and (b) 1.3 V.

FIG. 21 is a photograph showing the representative drop shape and the corresponding contact angle obtained on a coating just after its fabrication.

FIG. 22 is a photograph showing the representative drop shape and the corresponding contact angle obtained on a coating after four weeks of exposure in air.

FIG. 23 is a chart showing the effect of the CuSO₄ concentration in the electrolyte (for a fixed H₂SO₄ concentration of 0.5 M) on the contact angle of two-layer deposits of 30 μm made by applying overpotential of 1.1 V.

FIG. 24 is a chart showing the effect of the CuSO₄ concentration in the electrolyte (for a fixed H₂SO₄ concentration of 0.5 M) on the contact angle of two-layer deposits of 100 μm made by applying overpotential of 1.1 V.

### DETAILED DESCRIPTION OF THE INVENTION

The following description of the preferred embodiments describes a porous metallic coating and method of making the same. For illustrative purposes the metallic porous coating described herein is a copper coating but other metallic coatings may be made in accordance with the teachings of the present invention.

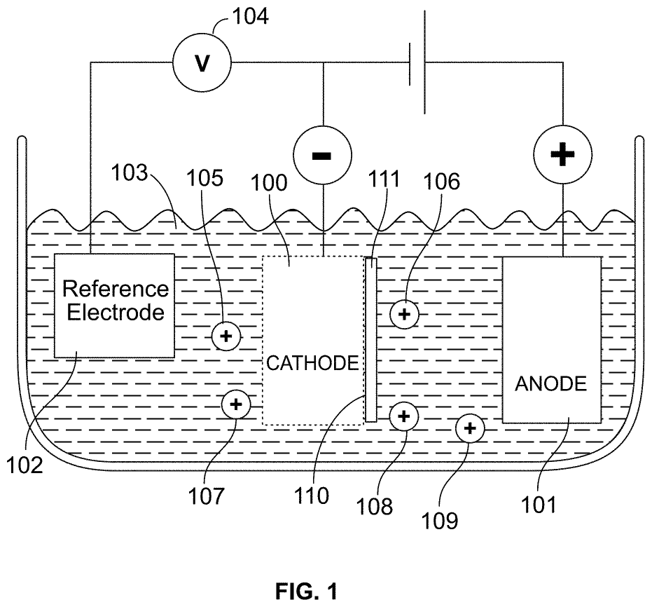

The present invention uses an electrodeposition process. The word electroplating can be used interchangeably instead of electrodeposition. As shown in FIG. 1, in one embodiment, the process uses three conductive electrodes 100-102 that are placed in an ionic solution 103 that acts as an electrolyte. As used herein, the term “substrate” refers to a surface, part thereof, overlaying surface, region, or item to which a coating is applied.

When a voltage 104 is applied, positively charged metallic ions 105-109 in the electrolyte move towards substrate 110, are neutralized on its surface and make a metal deposit 111. Substrate 110 is a part of the cathode 100 in the electrodeposition process. The electrodeposition voltage is measured against the voltage of reference electrode 102. If the reference electrode is composed of the same material as deposit 111, the voltage is called overpotential. The third electrode 101 in an electrodeposition bath is a non-reacting electrode which is a counter electrode.

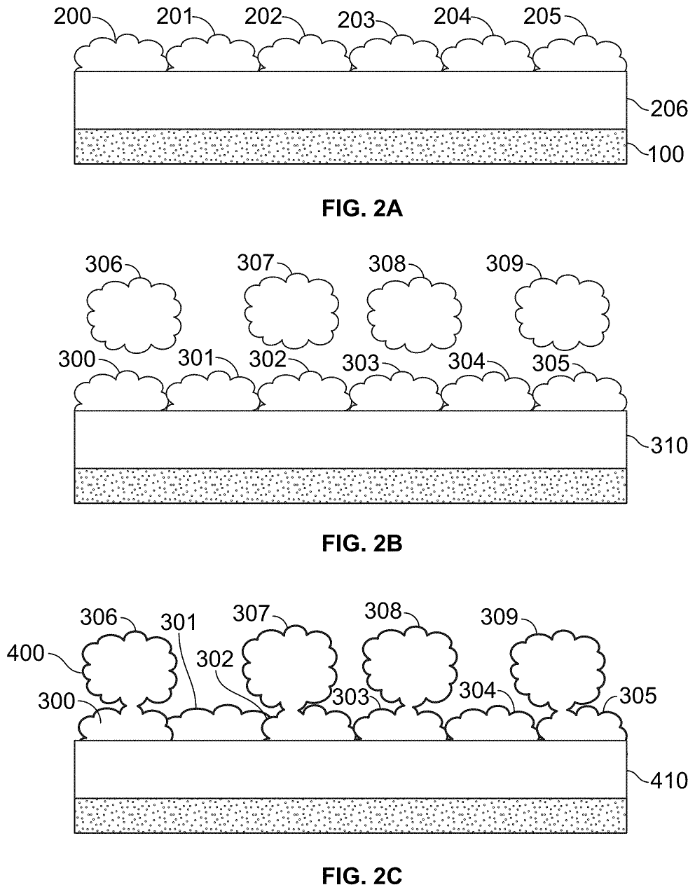

FIGS. 2A-2C show an embodiment of the present invention. An overpotential is first applied in a concentrated electrolyte, which creates a deposit which forms into a coating. The resulting deposit or coating 206 has high levels of roughness 200-205 which are developed on the coating surface as shown in FIG. 2A. At these conditions, the interface between the electrolyte and the deposit is very unstable resulting in the formation of a highly rough surface composed of porous structures 200-205 as shown in FIG. 2A. The structures may be fractals and form a three-dimensional network of porous structures. The morphological instability of the surface grows as the deposition process is continued and, beyond a certain stage, portions of the deposited fractals or porous structures or branches detach from the deposit 310 and grow independently 306-309 while the surface deposit 310 is covered by additional porous structures 300-305 as seen in FIG. 2B. An additional thin layer of deposit 400 as shown in FIG. 2C, which is made by applying a low overpotential for a short duration may also be formed. This covering layer binds the porous structures 300-305 and detached structures 306-309 of the coating together into a unified structure or composite 410.

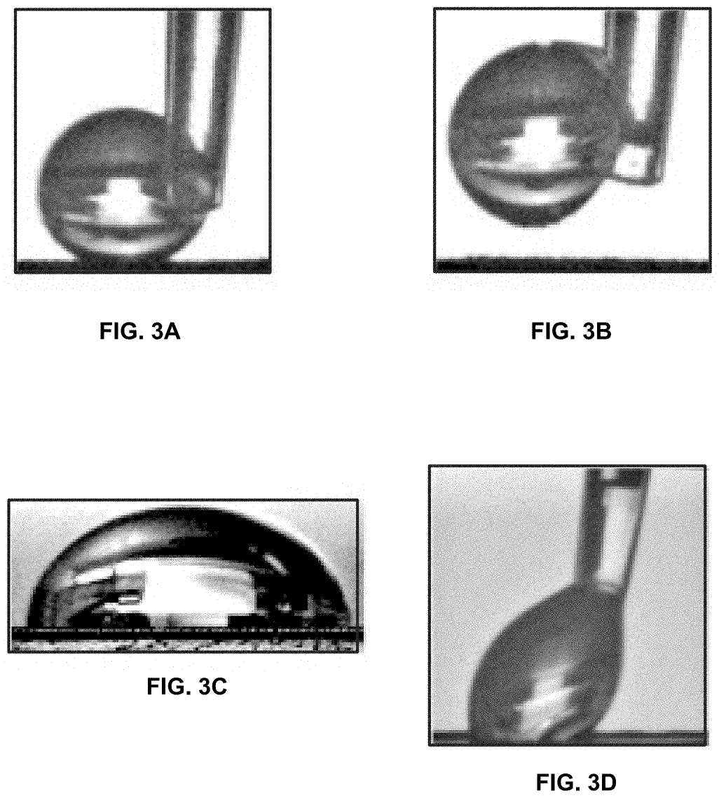

The resulting porous metallic coatings have excellent superhydrophobic properties with a water contact angle of 160°±6° and a contact angle hysteresis of 5°±2° for a copper coating. As shown in FIGS. 3A and 3B, for the porous coating made in accordance with one embodiment of the present invention, a water droplet can be moved freely and it can easily be separated. The water droplet does not adhere to the coating surface even if it is pushed onto the surface and it moves freely along the surface even at a high velocity. This behavior can be compared with the interaction of a water droplet on a typical copper surface which has a contact angle of around 90°. As shown in FIGS. 3C and 3D, the water droplet adheres to a typical copper surface after the first contact and cannot be separated. As also shown, when the syringe is moved, the droplet is not separated from the typical copper surface. Instead, the droplet is elongated and a large difference between the advancing and receding contact angles is observed as shown in FIG. 3D.

The resulting superhydrophobic metallic coatings made in accordance with one embodiment of the present invention provide solutions to several known problems such as corrosion, buildup of dust particles and loss of equipment efficiency caused by the presence of moisture on surfaces. The hydrophobic and/or superhydrophobic coatings of the invention may be used to protect surfaces from moisture and as a result they can be used for different applications such as anti-corrosion, anti-fouling, anti-condensation, anti-icing, self-cleaning, anti-condensation, anti-friction, and anti-clotting. The porosity of the coating of the present invention also makes it suitable in applications such as polymer-to-metal bonding and catalysis.

Copper superhydrophobic coatings made in accordance with one embodiment of the present invention may provide highly effective corrosion protection. The coatings may also combine the non-wetting characteristics of superhyrophobicity with the passivation mechanism of copper.

In one preferred embodiment, electrodeposition was performed using an AUTOLAB PGSTAT128N potentiostat (ECO Chemie, Utrecht, The Netherlands). A traditional three-electrode system was employed in which a copper sheet and a platinum mesh were utilized as the reference electrode and anode, respectively. Cathode was a 0.4×0.6 cm² silicon wafer and substrate was one side of the silicon wafer which was covered by a smooth copper film using physical vapor deposition (PVD). Electrolytes with different CuSO₄ concentrations were used while the concentration of H₂SO₄ in those electrolytes was kept constant at 0.5 M. The electrolyte was bubbled for 15 minutes before fabricating each sample in order to remove oxygen. Moreover, the electrolyte was replaced by a new solution after fabricating three samples to avoid contamination.

Since the reference electrode was composed of the same material as the deposit, herein, the term overpotential is used to refer to the electric voltage. A constant negative overpotential was applied to coat a substrate with a copper film. Herein, the overpotential is referred to by its absolute value, η.

The total amount of electrical charge (Q) was obtained from the current profile and utilized in the following equation to evaluate the deposit height (h):

$$h = \frac{Q M}{nF ρ A }$$

In the above equation, n is the number of transferred electrons, n=2 for copper deposition, F, A, M and p are, respectively, Faraday constant, surface area of the substrate, molecular weight and density of the copper deposit.

To determine the effects of the overpotential on the deposit morphology, copper coatings with 30 μm thickness were deposited using different overpotentials in the range of 0.1 V to 1.3 V. In addition, coatings with 100 μm thickness were fabricated to determine the effect of the deposit height on the superhydrophobic characteristic of the coating.

The surface morphologies of the deposited coatings discussed below were examined using the FEI Quanta 600 scanning electron microscope (SEM). The PHI Quantera x-ray photoelectron spectroscopy (XPS) was utilized to obtain the chemical state of the deposit. In order to show the re-entrant geometry of the deposit topographical features of FIG. 18, the cross section of one of the surface structures was revealed through a cross section formed by a focused ion beam using the FEI Helios 600 NanoLab.

Droplets of deionized (DI) water of 4.5 μl volume were used. To determine the effects of the overpotential and electrolyte concentration on the wetting characteristic of the deposit, the static contact angles of the droplet were obtained using the FTA 200 contact angle measurement system at room temperature. At each overpotential and electrolyte concentration, two samples were fabricated and on each sample, three contact angle measurements were performed. Angles were deduced from the measurements using the ImageJ software. The contact angle hysteresis of a moving droplet on the superhydrophobic coating was measured five times using the same equipment. All results are reported as the mean number±standard deviation. In order to further show the non-wetting characteristic of a superhydrophobic surface, full rebound of a falling droplet was captured at the speed of 3000 Hz by a XS-5 high speed camera (IDT; Tallahassee, Fla., USA).

FIGS. 2A-2C show a schematic illustration of one embodiment of the invention used to fabricate a superhydrophobic coating made of copper. FIG. 2A presents the incipient formation of the cauliflower-shaped porous structures 200-205 on the deposit surface in the concentrated electrolyte of 1 M CuSO₄, when overpotentials greater than 0.9 V in magnitude were applied.

At these conditions, the interface between the electrolyte and the deposit 206 is very unstable. At this level of instability, fractal or porous structures 200-205 such as those shown in FIG. 2A are formed. The morphological instability grows with time and/or when a higher overpotential is applied. As the application of voltage continues, some parts of the porous structures detach from the deposit 301 and grow independently into additional detached porous structures 306-309. In addition, the surface of the deposit is also covered by additional porous structures 300-305 as seen in FIG. 2B. This process can be repeated several times and the resulting coating may be a one-layer deposit or may be several layers in thickness.

The coating is reinforced by a covering layer consisting of a thin layer of copper that is made by applying a low overpotential (0.15 V) for a short duration (10 sec). This layer is shown in FIG. 2C as layer 400. Thin layer 400 may be several nanometers in thickness and does not interfere with the porosity of the porous structures. Additional covering or reinforcing layers may be provided resulting in a multiple layer metallic porous coating having a plurality of layers. This coating shown in FIG. 2A is hydrophobic and may also be formed as a superhydrophobic layer. Increasing the morphological instabilities of the deposit in FIGS. 2B-2C by increasing porosity enhances the superhydrophobic property of the coating. Materials which can be used to make this kind of porous coating include metal, metal alloy, metallic compound, conductive polymer or combination of thereof. In addition, coating materials can be selected from rare metals, rare metal alloys, rare metallic compounds or combinations of thereof.

The present invention may be used to coat a region of a surface to create a porous portion thereon. The coating, as shown in FIGS. 2A-2C, is comprised of a plurality of porous structures that are attached to the surface and a plurality of detached porous structures or portions that are loosely attached to the attached porous structures. In addition, at least one reinforcing layer covers the attached and detached porous structures or portions, which binds the attached and detached porous structures or portions together.

In another embodiment, the invention provides a method for creating a porous coating on a substrate by electrodeposition or electroplating by first providing a substrate as a part of a cathode and also providing an anode. A voltage is applied to create at least one layer having a plurality of porous structures thereon. Additional porosity may be created by continuing to apply a voltage to cause portions of the attached porous structures to detach. Lastly, at least once applying a voltage to create a reinforcing layer that covers the porous structures and the detached portions, which binds the porous structures, and the detached portions together.

Advantageously, the methods of the present invention and resulting coatings are not limited to a single or particular metal. The coating material may be a metal, metal alloy, metallic compound, conductive polymer or combination of thereof. In addition, the region of the surface, substrate or article to be coated, may also be a metal, metal alloy, metallic compound, conductive polymer or combination of thereof. Thus, the substrate and coating may be the same material or be composed of different materials. If the porous coating material is different from the substrate, adhesion of the coating to the substrate may be improved by applying one or more intermediate layers. The material of the intermediate layers may be different from those of the coating and substrate and they may be applied as an adhesive layer to improve bonding of the coating to the substrate. The material of the reinforcing layer may also be different from that of the rest of the coating and it may be selected from rare metals, rare metal alloys, rare metallic compounds or combination of thereof.

In another embodiment, the method described above and resulting coating may be applied to a surface of an article or a substrate. In addition, a layer composed of attached porous structures may also be provided. A thin covering layer may also be applied using the methods described above, using either the high overpotential and/or lower overpotential described above. The covering layer may act as a reinforcing layer and/or it may be used to impart an additional property to the coating such as a catalytic or binding property. Applications for this embodiment include use as a catalyst, catalytic material or binding layer.

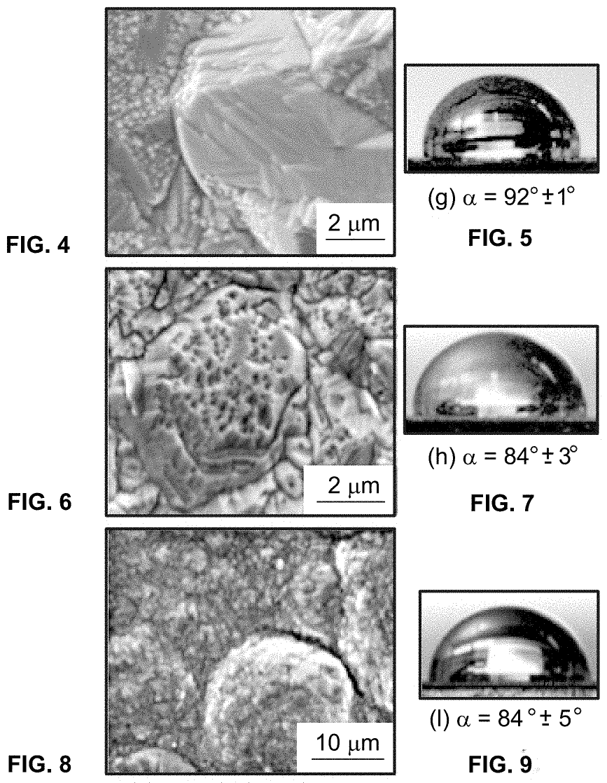

The effect of the overpotential on the surface topography and contact angle of a deposit was studied by depositing copper coatings with 30 μm thickness at different overpotentials from an electrolyte of 1 M CuSO₄ and 0.5 M H₂SO₄. FIGS. 4-15 are micrographs of the surface topographies of the one-layer deposits formed by applying overpotential in the range of 0.1 V to 1.1 V, in increments of 0.2 V, and corresponding water droplet shapes and contact angles. The figures show the median values of the contact angles, the standard deviations, and the representative shape of a 4.5 μL water droplet on the deposited surfaces.

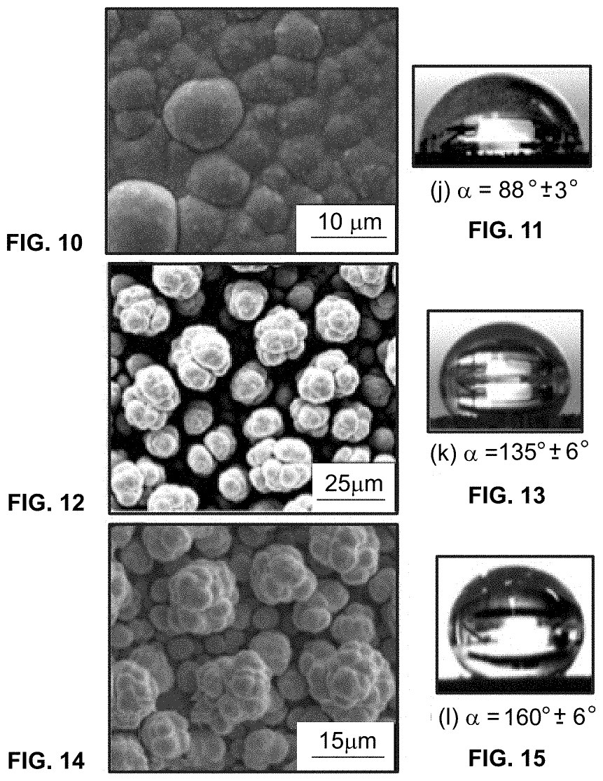

The deposit surface features are observed to change gradually from needle-shaped structures at low overpotentials (η=0.1 V) as shown in FIG. 4 to cauliflower-shaped structures at high overpotentials (η=1.1 V) as shown in FIGS. 14 and 18. For an increase in overpotential from 0.1 V to 0.7 V, a gradual transition from the needle-shaped structures shown in FIGS. 4 and 6 to the spherical-shaped structures in FIGS. 8 and 10 is observed.

In a preferred embodiment, the voltage applied during the creation of the porous structures and of the detached porous structures or portions are both overpotentials, and may be the same voltage or different voltages. The voltage applied may be in the range of 0.9 V to 1.1 V.

The voltage applied during the creation of the covering or reinforcing layer is an overpotential that may be less than the voltage applied during the creation of the porous structures. The voltage applied for this overpotential is in the range of 0.1 V to 0.2 V or less.

From FIGS. 5, 7, 9, and 11 it is found that the needle-and spherical-shaped deposit surface textures (FIGS. 4, 6, 8, and 10) have negligible effect on the contact angle, which is observed to remain in the vicinity of 90°. The results obtained for the contact angles of these deposits agree with the value of 90° reported in the literature for smooth copper films exposed to the ambient conditions, which are always covered by a thin layer of Cu₂O.

At overpotentials greater than 0.7 V, morphological instabilities are enhanced and cauliflower-shaped surface features are formed as shown in FIGS. 12 and 14. As a result, the contact angle increases to larger values. As seen in FIGS. 13 and 15, the coatings made by applying 0.9 V and 1.1 V overpotentials exhibit contact angles of 135°±6° and 160°±6°, respectively.

When a water droplet is brought in contact with the deposit made by applying 1.1 V overpotential (FIG. 14), it does not leave the syringe tip. Similar to what has been reported for the lotus leaves, the droplet is repelled by these surfaces and cannot be placed on the surface. This behavior shows the extreme non-wetting property of the resulting metallic porous coating.

Similar to the lotus leaves, the areas of the deposit surface, which allow the droplet to be placed on, such as the one shown in FIG. 15, may contain a point defect. The increase in the morphological instabilities by increasing overpotential can be explained by the model of unstable growth during electrodeposition presented by Aogaki et al. Based on this model, when a deposit is made by applying larger overpotentials the growth time constant is smaller and consequently, at a particular deposition time, more morphological instabilities are formed. FIG. 18 is a high-magnification micrograph showing porous structures 500-504, among others, of the surface topography. FIG. 18 also shows that these structures are composed of pores with different sizes. This suggests the formation of fractal structures, resulting in the multi-scale roughness on the coating deposited through the use of a high overpotential of 1.1 V, resulting in the superhydrophobic behavior of the coating.

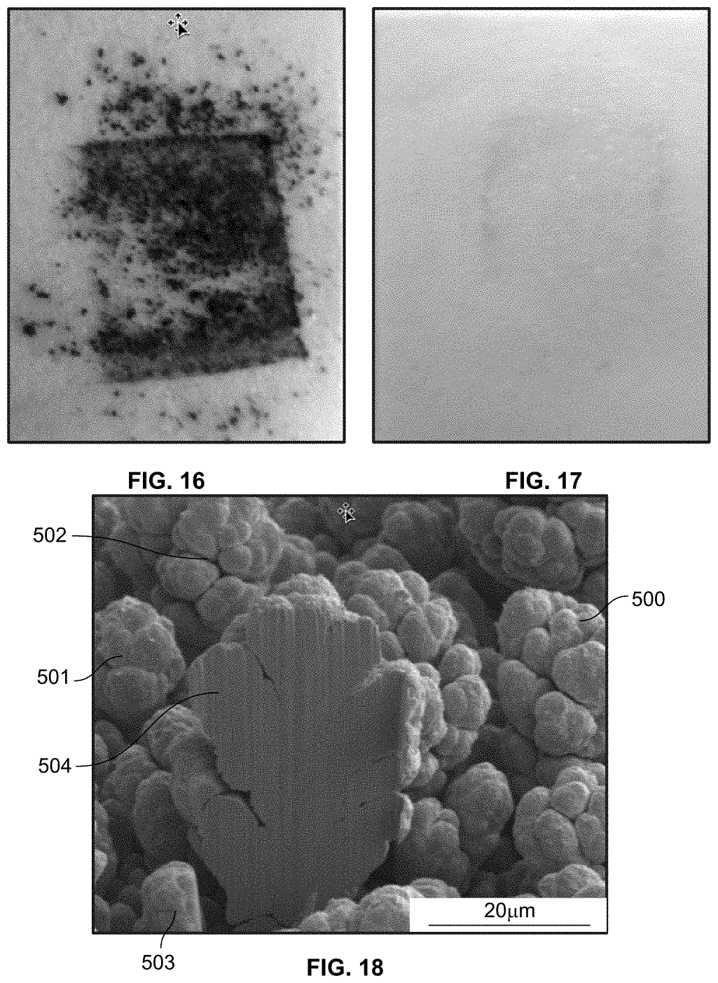

FIG. 16 shows the footprint of a deposit surface made by applying a 1.1 V overpotential before the reinforcing layer is applied on a piece of scotch tape (3M; St Paul, Minn., USA). The detached porous structures shown in FIG. 2B can be easily removed when the tape is peeled off from the surface. Depositing at least one reinforcing layer of copper by applying a low overpotential (0.15 V) for a short duration (10 sec) binds the detached structures on the deposit surface. Therefore, these branches are not removed from the surface when the tape is peeled off, as shown by the footprint of a multi-layer deposit on a piece of tape in FIG. 17. Applying the low overpotential layer 400 binds the porousstructures of the coating together into a unified structure that prevents delamination.

FIG. 18 shows the micrograph of the multiple-layer deposit. In this figure, the cross section of porous structure 504 is revealed through a cut made by ion beam. This cross section shows the re-entrant geometry of the porous structures, which is considered as the main reason for their superhydrophobic characteristic. FIG. 18 also shows that applying the thin reinforcing layer does not have a considerable effect on the surface topography.

As shown in FIGS. 14 and 18, the superhydrophobic coating created by the invention produces a layer comprising a three dimensional network of fractal structures. The invention also provides for the application of a reinforcing layer that is applied over the three dimensional layer to bind the structures together. Of course, the present invention may also be used to create hydrophobic coatings.

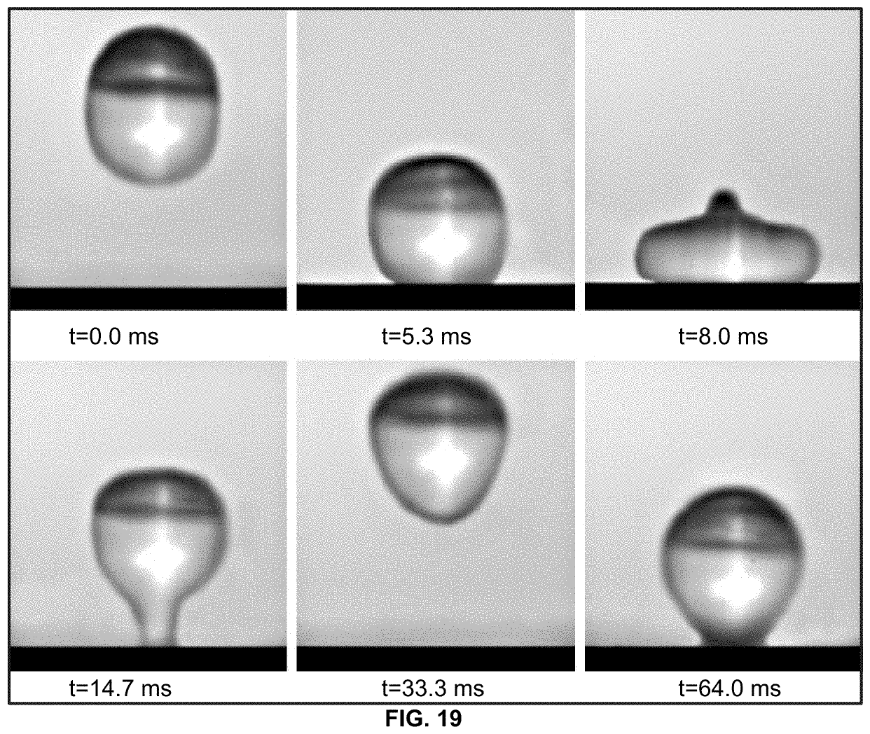

FIG. 19 shows six successive snapshots obtained from the full rebound of a 4.5 μL droplet on the two-layer deposit made by applying an overpotential of 1.1 V for the formation of the first layer of coating followed by applying the second layer of copper at an overpotential of 0.15 V for 10 seconds. This bouncing sequence is similar to what has been reported for the dynamic behavior of a drop on a superhydrophobic surface in the literature. The snapshot at t=0 ms shows the water droplet at the initial condition as it is about to hit the surface and the snapshot at t=5.3 ms shows the image of the water droplet when it impinges on the surface and starts to deform. The droplet is completely deformed as seen at t=8.0 ms. For impingement on the superhydrophobic surface, the kinetic energy of the droplet is restored into the surface energy, which allows the droplet to bounce off the surface as observed at t=33.3 ms. and the droplet impinges on the surface again at t=64 ms.

In addition to the quantitative and qualitative observations on the wetting characteristics shown above, an examination of the surface chemical composition of the resulting porous metallic coating made by the present invention shows that the methods discussed above do not change the chemistry of the deposited surface. At the ambient condition, copper always appears in one of two oxidation states, of which Cu₂O is the most common state that is associated with the copper color. Further oxidation of copper produces CuO, which is easily distinguished from Cu₂O because of its black color. The deposits shown in FIGS. 4, 6, 8, 10 12 and 14 and FIG. 18 have the copper color associated with the Cu₂O oxidation state. Formation of a black CuO deposit was observed when overpotentials higher than 1.1 V were applied.

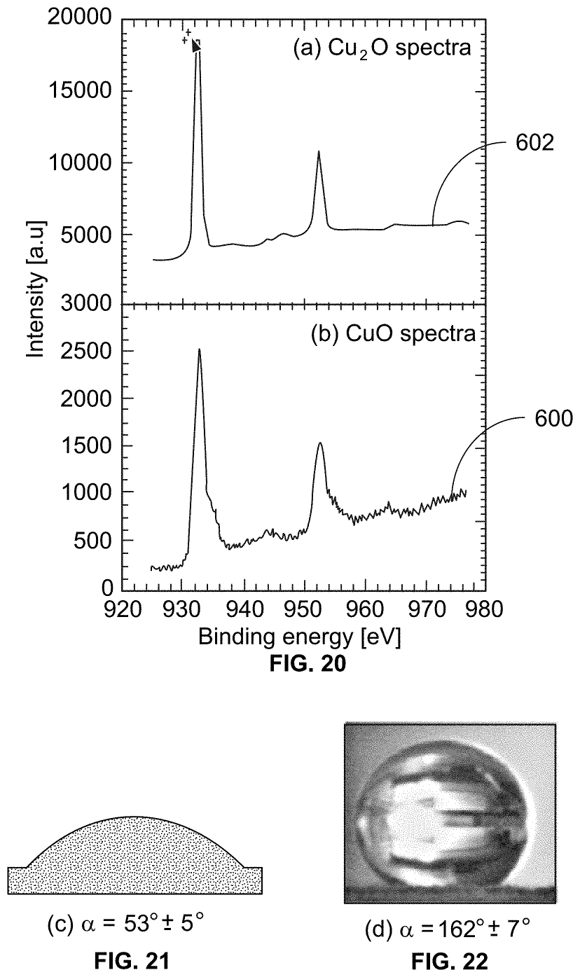

In order to determine the chemical state of the copper- and black-colored deposits, XPS analysis was carried out on two coatings made by applying 1.1 V and 1.3 V overpotentials, and the corresponding spectra are shown in FIG. 20. The spectrum of the black deposit shown by line 600 shows high intensity shake-up satellites after the peaks. Moreover, these peaks are broader than the ones displayed by line 602 for the copper-colored Cu₂O deposit. High intensity shake-up satellites and broad peaks are the main characteristics of the CuO spectrum which make it distinct from the spectrum of Cu₂O. The electron micrograph of the black deposit is similar to that shown in FIG. 14 for copper-colored Cu₂O deposit obtained by applying an overpotential of 1.1 V, and is not depicted herein. Furthermore, the representative drop shape, the average contact angle, and its standard deviation obtained on three different black coatings just after their fabrication have been displayed in FIG. 21. As this figure shows, the as-deposited black coating exhibits a complete-wetting characteristic, with an average contact angle of 53°, despite its multi-scale roughness. After four weeks, the wetting property of this deposit was found to change to being superhydrophobic and the average contact angle of 162° was measured on the three samples, as shown in FIG. 22.

The shift from a complete wetting characteristic to superhydrophobicity after several weeks at the ambient condition is in agreement with studies reported in the literature for the textured CuO surfaces. The change of the wetting characteristic of the black CuO deposit may be attributed to a reversible superhydrophobicity to superhydrophilicity transition of textured CuO surfaces by alternation of ultraviolet (UV) irradiation and dark storage. It is believed that the transition is attributed to the water and oxygen adsorption on the defective sites made on the surface by UV irradiation. During electrodeposition, as in UV radiation exposure, defects are formed on the deposit surface. While water adsorption on the surface defects is kinetically favorable, thermodynamically, the defective sites are more prone to adsorb oxygen. Initially, adsorption is mainly governed by the kinetic effect, as a result of which, most of the defective sites are occupied by the hydroxyl group. Hydroxyl adsorption results in the superhydrophilic characteristic of the as-deposited black coating. Adsorption of the hydroxyl groups gradually shifts the surface to a thermodynamically unstable condition and provides the driving force for the oxygen adsorption. Therefore, the hydroxyl groups are replaced gradually by oxygen atoms. After several weeks, the defective sites are mainly occupied by oxygen and the surface shows superhydrophobic characteristic. In addition to the oxygen adsorption on the defective sites of the CuO coating, XPS analysis showed a large amount of carbon adsorption on the surface of the black deposit. After four weeks, carbon content on the surface of the CuO and Cu₂O coatings reaches 50% and 23%, respectively. High carbon adsorption on the surface of the black CuO coating may be regarded as the second reason for the change in the wetting property of this coating after extended exposure to the ambient environment.

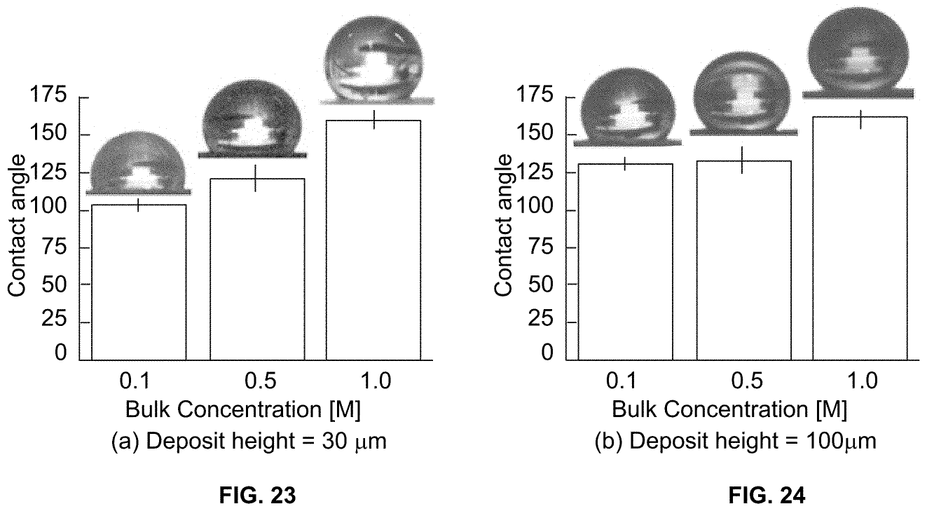

In addition to the effect of overpotential discussed above, superhydrophobic characteristic of the deposit also depends on the bath concentration and deposit thickness. The effect of the bath concentration and deposit thickness on the contact angle of a two-layer deposit was studied by depositing copper coatings with 30 μm and 100 μm thickness at an overpotential of 1.1 V from the electrolytes with 0.1 M, 0.5 M, and 1 M CuSO₄ concentration. The concentration of H₂SO₄ was kept constant in 0.5 M for all three electrolytes. At each bath concentration and deposit thickness, the contact angle of a 4.5 μL droplet was measured on two different samples and on each sample, the measurement was repeated three times. The median values of the contact angles and the representative shapes of the droplet on the deposits made from the electrolytes with different bulk concentrations are shown in FIGS. 23 and 24 for deposit heights of 30 μm and 100 μm, respectively. As these figures show, the average contact angle increases from 103° to 160° and from 132° to 162° for the deposit heights of 30 μm and 100 μm, respectively, when the CuSO₄ concentration in the electrolyte increases from 0.1 M to 1 M. This effect of the electrolyte concentration on the deposit contact angle can be attributed to the unstable growth for the effect of bath concentration on the morphological instabilities of the deposit. Accordingly, at higher bath concentrations, the growth time constant is smaller and consequently, at a particular deposition time, more morphological instabilities are formed.

As also shown in FIGS. 23 and 24, increasing electrolyte concentration from 0.1 M to 0.5 M results in a 17% enhancement in the contact angle of the 30 μm deposit and a negligible change in the contact angle of the 100 μm deposit. In addition, if the bath concentration changes from 0.5 M to 1 M, a greater increase in the deposit contact angle is obtained at the deposit height of 30 μm compared to the deposit height of 100 μm. Consequently, the effect of the electrolyte concentration on the contact angle is more evident at the smaller deposit heights. Furthermore, the contact angle of the 100 μm deposit is higher than that for the 30 μm deposit at all electrolyte concentrations shown in FIGS. 23 and 24.

The effects of the deposit height on the contact angle is the result of the unstable growth during electrodeposition which shows that the level of surface irregularity is enhanced at increased deposition times. During electrodeposition, like other unstable growth processes, protrusions develop with time and the surface roughness is higher at larger deposit heights. Therefore, when deposition continues for a longer time and a thicker deposit is formed, the effect of the electrolyte concentration on the deposit contact angle is diminished and a larger contact angle is observed. As FIGS. 23 and 24 show, both 30 μm and 100 μm coatings satisfy the contact angle requirement for superhydrophobicity (a>150°), if they are made by applying 1.1 V overpotential in an electrolyte with 1 M CuSO₄ concentration. During the first step deposition of these superhydrophobic coatings, current density varies from zero to a limiting value. This limiting value corresponds to the mass transfer limitation of the process and is independent of the deposit height. At the above conditions, the formation of a superhydrophobic coating average limiting current density of 7553±424 was obtained.

In addition to the static contact angles (FIGS. 23 and 14) and the full rebound of the droplet on the surface (FIG. 19), contact angle hysteresis may be determined to further show the superhydrophobic characteristic of the multi-layer deposit. To determine the contact angle hysteresis, a 4.5 μL droplet was formed with a syringe and brought in slight contact with the surface. As shown in FIG. 3A, the water droplet is attached to the syringe, and then was slowly moved along the sample surface and the contact angle hysteresis was deduced from the advancing and receding contact angles, which were measured at the front and back of the moving droplet, respectively. This measurement was repeated five times for a two-layer deposit with a 30 μm thickness which was made by applying a 1.1 V overpotential in a bath of 1 M CuSO₄ concentration as shown in FIG. 18. The representative shape of the droplet that is moved on this surface by the syringe is shown in FIG. 3A. On this surface, the median value of the contact angle hysteresis and the standard deviation were obtained to be 5° and 2°, respectively. On this two-layer deposit, the droplet can be moved freely and it can be separated from the surface easily as shown in FIG. 3B. A similar behavior is observed when the droplet is moved faster on the surface. The water droplet does not adhere to the surface even if it is pushed onto the surface; furthermore, it moves freely along the surface even at a high velocity. In contrast, a water droplet adheres to a non-superhydrophobic surface after the first contact and cannot be separated as shown in FIG. 3D which shows an example of this behavior of the droplet on a two-layer deposit with 30 μm thickness which was made by applying 1.1 V overpotential in a bath of 0.5 M CuSO₄ concentration. As this figure presents, when the syringe is moved, the droplet is not separated from the surface; instead it is elongated and a large difference between the advancing and receding contact angles is observed.

1. An article, comprising: a surface having at least one region; and a porous coating on said at least one region of said surface, wherein the coating comprises a plurality of porous structures attached to said at least one region of said surface and at least one layer covering said porous structures.

2-28. (canceled)

29. An application of the article of claim 1 wherein said coating is used in anti-corrosion, anti-fouling, anti-condensation, anti-ice, self-cleaning, anti-condensation, anti-friction, or anti-clotting applications.

30. An application of the article of claim 1 wherein said porous coating is used to enhance the bonding of said coating to paint or polymer.

31. An application of the article of claim 1 wherein said porous coating is used as a catalyst.

32. The application of claim 31, wherein the said covering layer comprises a catalytic material.

33-35. (canceled)
